(19) United States
(12) Patent Application Publication
(10) Pub. No.: US 2003/0046217 A1
(43) Pub. Date: Mar. 6, 2003

(54) Procurement negotiation method

(76) Inventors: Barry Thomas Deaderick, Jonesborough, TN (US); Kent L. Ervin, Kingsport, TN (US)

Correspondence Address: Susan F. Johnston, Attorney at Law, P.O. Box 4449, Johnson City, TN, 37602-4449, US

(21) Appl. No.: 09/949,187

(22) Filed: Sep. 6, 2001

(51) Int. Cl. G06F 17/60

(52) U.S. Cl. 705/37

(57) ABSTRACT

Disclosed herein is a computerized business method for determining the fairness of a purchase of an item relative to previous purchases of the item by other buyers. The method comprises comparing an offer for an item to a fairness indicator determined through analyses of a plurality of sets of sales contract terms controlling a plurality of previous purchases of the item by a group of previous buyers, with each of the sets of sales contract terms controlling a previous purchase.

### CROSS REFERENCES TO RELATED APPLICATIONS

This application claims no benefits from any earlier filed United States or foreign patent applications.

### BACKGROUND OF THE INVENTION

1. Technical Field

This invention relates generally to computerized methods useful in sales negotiations and more particularly to computerized methods useful in determining the fairness of an offer.

2. Background

The profitability of a company is directly dependant upon expenses incurred for standard, non-customized, goods and services. A significant portion of expenses for standard items is often negotiable to some extent. Examples of such negotiable expenses includes the cost of raw materials for use in product manufacturing, the cost of office supplies, the cost of equipment and parts, the cost of various types of services, and the cost of utilities. For a given standard item, with the term item including goods and services, an individual or corporate buyer typically shops to compare the sales terms of different vendors. Comparison shopping is often a time-consuming venture. However, in practice, a buyer who spends a high amount of time in comparison shopping does not necessarily procure his items under sales contract terms that are relatively favorable, when compared to sales contract terms obtained by other buyers in the market for the same item. Besides the objective factors affecting pricing such as quantity sold, availability, method of delivery, warranties, and economic fluctuations, many subjective factors affect the success of a buyer. Such subjective factors includes the buyer's negotiating skills, the purchasing history between the buyer's company and the vendor, personal relationships, and familiarity. Even within the same company, separate buyers for the same item negotiating separately from each other often procure the same item at a different price per unit.

Efforts have been made to use the internet's World Wide Web network system for eliminating some of the variables in purchasing. For instance, a buyer or seller can often compare their pricing for an item by comparison to sale prices offered for the same item advertised on a vendor's web page. On-line auction sites such as the PRICELINE.COM service between buyers and sellers provide new opportunities for direct negotiation through a bidding system. Even with these new tools available, the purchase price disparity between individual buyers for standard items is often significant.

It is an object of the present invention to provide a new business method that would serve to reduce the buying disparity between buyers for standard items. It is a further object of the present invention to provide a method whereby a potential buyer can evaluate the fairness of a purchase offer, as compared to purchases made for that item by other buyers in the market. It is a still further object for such method to be useful to a vendor in determining the fairness of his selling price of the item. These objects and others are met by the present invention.

### BRIEF SUMMARY OF THE INVENTION

The present invention is a computerized method comprising the steps of:

providing a database program adapted for storing multiple sets of data;

building a purchase history database for at least one item by inputting a plurality of sets of sales contract terms controlling a plurality of previous purchases of the item by a group of previous buyers into the database program, each of the plurality of sets of sales contract terms controlling one of the plurality of purchases made by one member of the group of previous buyers, each of the plurality of sets of sales contract terms including a price paid and a quantity;

providing a logic program adapted for interfacing with the database program and analyzing the purchase history database;

calculating a fairness indicator for the item by analyzing the purchase history database using the logic program; and

determining the fairness of the offer by comparing the offer to the fairness indicator, the offer including a sale price.

### BRIEF DESCRIPTION OF THE DRAWINGS

FIG. 1 is a diagram of the system architecture.

FIG. 2 is a flow diagram showing the steps of the present method and the interface between previous buyers with the system, and the interface between users and the system.

FIG. 3 is an example of a delineated purchase record used for inputting new data into the purchase history database.

FIG. 4 is a web screen transmitted at the user site for initiation of the method.

FIG. 5 is a web screen transmitted at the user site showing an example of fairness indicators calculated for an item.

FIG. 6 is a web screen transmitted at the user site showing discarded data sets for a class-directed fairness comparison.

### DETAILED DESCRIPTION

The present invention is a computerized method that provides a buyer with a way to meaningfully compare his offer for an item to a database of sales contract terms controlling actual previous purchases of the same item. This method is distinct from previous purchasing methods and tools in that it provides a mechanism whereby a buyer (or seller) can compare a purchase offer to sets of sales contract terms gathered from actual purchases of the item, instead of the traditional comparison of sale prices offered by vendors.

It is important to first clarify the definitions of purchase terms used herein to describe the invention. The term “offer” is used herein to refer to a set of purchase terms. The offer may be an offer to buy or an offer to sell. It does not matter whether the offer has been extended to the other party or, if extended, whether the offer has been accepted by the other party. Therefore, the present method may be used to determine the fairness of an offer before, during, or after a purchase is actually made. The term “sales contract terms” is used herein to refer to terms that have been actually offered and accepted, with all obligations under the contract preferably being previously performed. The term “item” refers to a standard good or service. Also, in a situation where a company has different buying agents independently responsible for negotiating the purchase of the same item, those agents are considered to be separate buyers in the present invention.

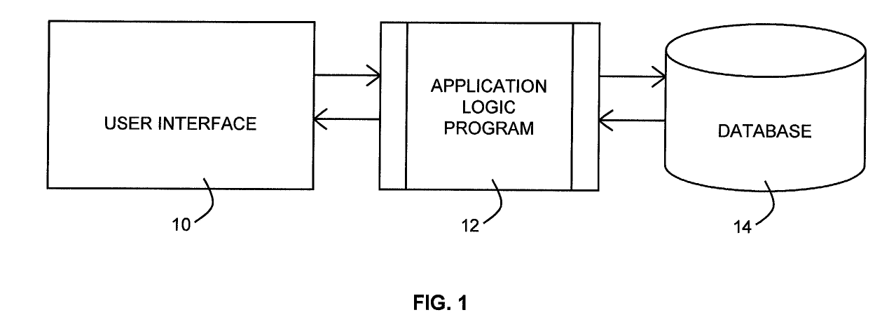

The method of the present invention requires a computer system having a database program adapted for storing multiple sets of data and a logic program adapted for interfacing with the database program and analyzing the data stored therein. A suitable database program includes relational tables where each table has a name, columns of data fields and rows containing data. A suitable logic program manages and controls access to the data by users. A useful logic program is a program capable of associating data from the database, filtering unwanted information and preparing data for presentation to the user by the user interface. The computer system is preferably an internet network client/server system where the database and logic program are located on a server site and the logic program is adapted to communicate over the network to at least one client site. FIG. 1 shows a preferred three tier architecture wherein the user interface 10 manages presentation of the information, the application logic program 12 manages selection and retrieval of the information, and the database 14 manages the storage and organization of the data records.

In the present method, the computer system is used to build a purchase history database for at least one item by inputting a plurality of sets of sales contract terms controlling a plurality of previous purchases of the item by a group of previous buyers into the database. Each set of sales contract terms controls a purchase made by a previous buyer. Each set of sales contract terms must include at least an identification of the item, the price paid and the quantity bought. It should be understood that while the database most usefully includes a plurality of sub-databases, each representing the purchase history of a different item, the method is described hereinafter in terms of a single item for convenience. The database building step is preferably conducted by a system operator entering data into the database program at the server site. However, the gathering, processing, and downloading of the data into the database can be further automated.

It is preferable for the sales contract terms to be provided directly by the actual previous buyers, instead of by vendors or other sources, so that the actual terms of the sale are more likely to be reported.

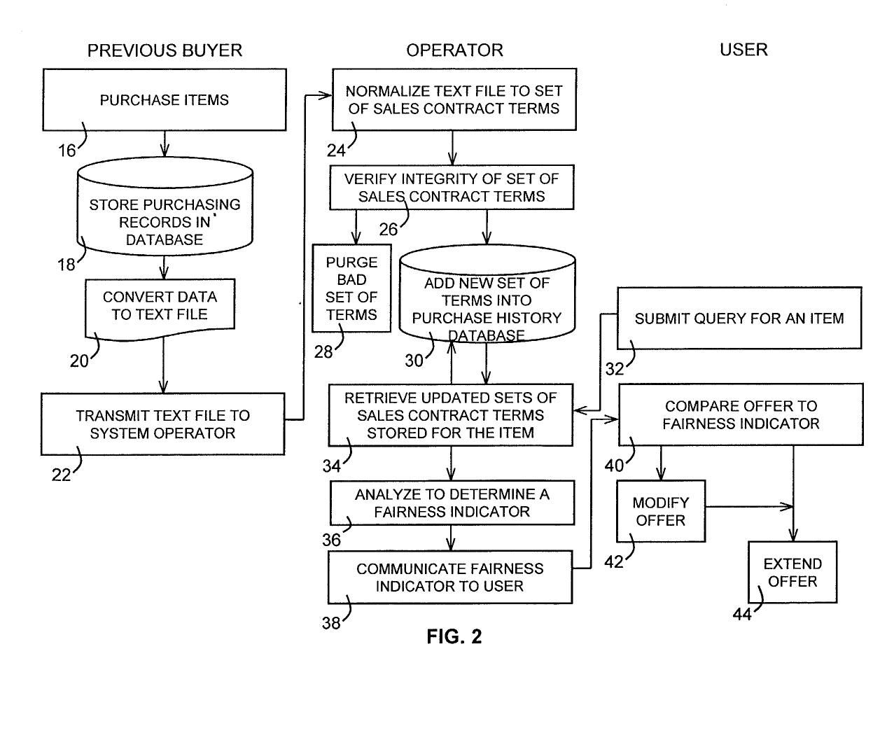

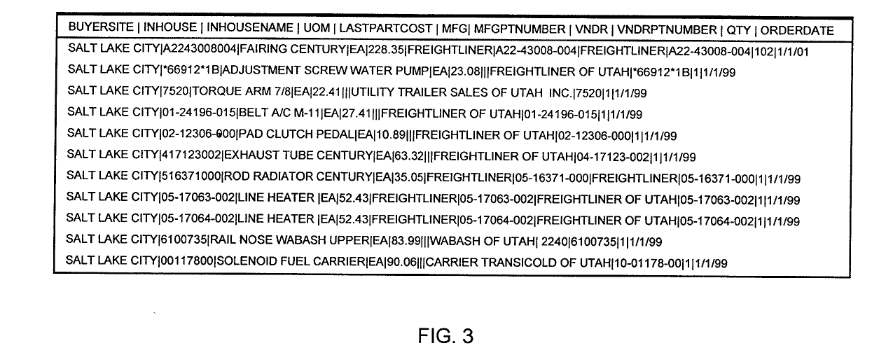

FIG. 2 is an exemplary graph illustrating the interface of a previous buyer with the system and the interface of a user with the system in the present method. FIG. 2 shows that when a previous buyer, such as a purchasing agent, purchases items 16, a record of the purchases is made 18 in the previous buyer's existing accounting database in the language native to the particular accounting database program. The previous buyer's accounting database records are then converted to a text file using a universal text format such as comma separated values or other delimited format 20. Then the previous buyer transmits the text file to the system operator 22, preferably by electronic transmission via the internet. Then the system operator proceeds to use the text file to build a purchase history database in steps 24, 26, 28, and 30. FIG. 3 illustrates an example of a text file where the data is delimited by bars. Database managers will recognize that such a delineated text file can be easily formatted for inputting into the database program upon which the purchase history database system is built.

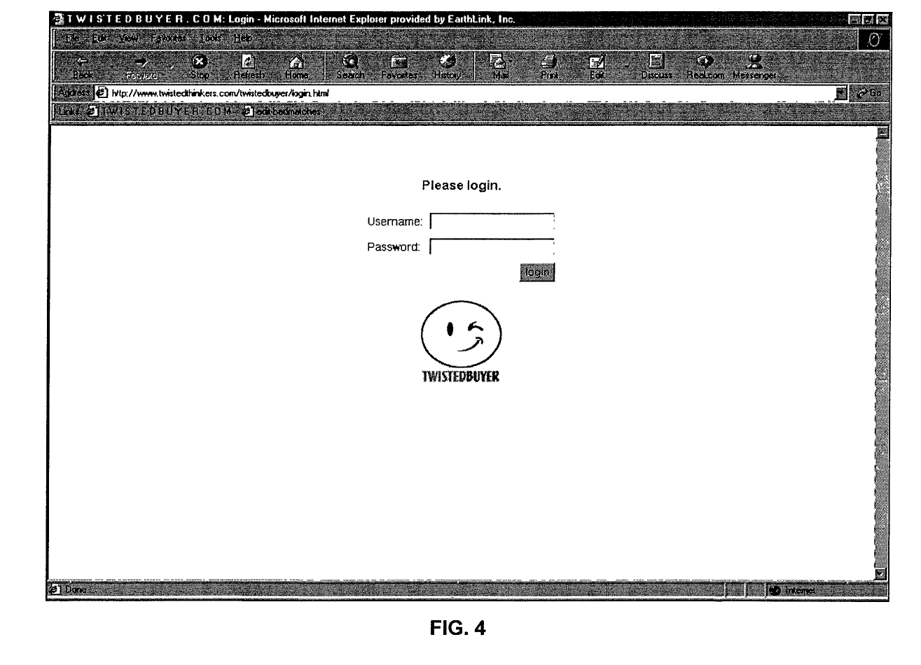

With reference again to FIG. 2, a user interested in negotiating the sale/purchase of an item implements the system by submitting a query for the item of interest into the logic program of the system 32. FIG. 4 shows an exemplary network user screen for logging onto the system. With reference again to FIG. 2, the logic program then interfaces with the purchase history database to retrieve the current sets of sales contract terms stored for the item 34. The logic program then calculates a fairness indicator for the queried item by analyzing the purchase history database 36. The fairness indicator is then communicated 38 to the user in a context sufficient so that the user can comparatively determine the fairness of his offer for the item. Examples of a suitable fairness indicator include a single value such as the average price paid per unit, a highest price paid value, a lowest price paid value, and a simple or complex graphical display or formula.

With still further reference to FIG. 2, the user determines the fairness of an offer presented for analysis by comparing the offer to the fairness indicator 40. Like the sales contract terms, the offer must identify the item, a price, and a quantity. After the fairness of the offer is determined, the user may decide to modify his offer 42 or extend the offer in a procurement negotiation 44.

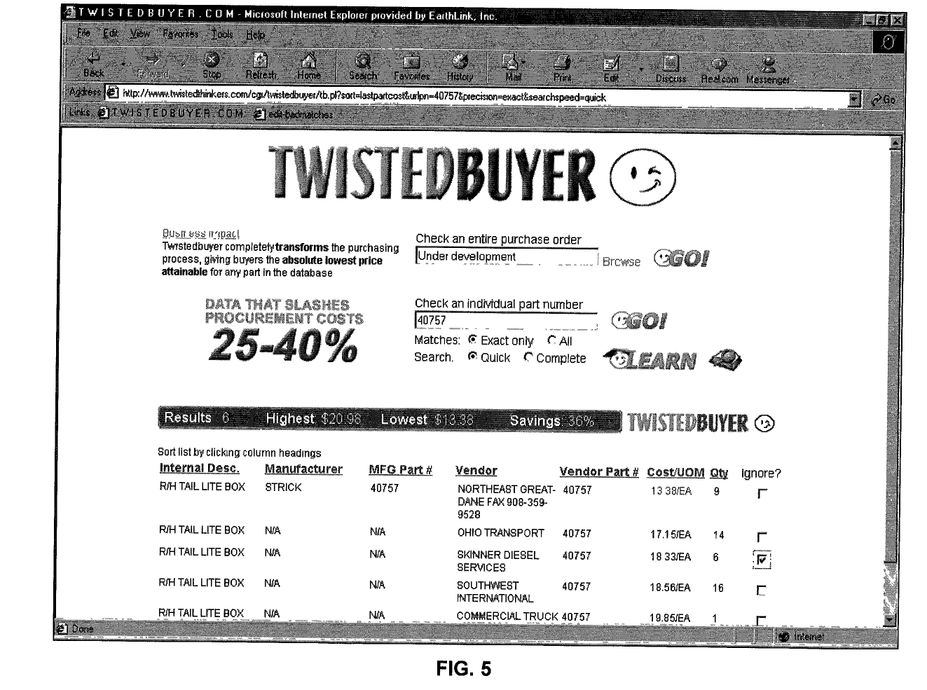

FIG. 5 is a copy of a user screen provided in a theoretical example. In this example, the user's query is for an item having a vendor part number of 40757. In this example, six sets of sales contract terms are retrieved from the purchase history database. It can be seen that the fairness indicator communicated to the user in this example is a combination of the highest and lowest price paid, as well as a listing of every set of sales contact terms retrieved.

In the preferred embodiment of the invention, the logic program is adapted to communicate with many different client sites across internet connections, each user inputting his offer into the logic program by way of his client site interface with the logic program. It should be understood that the offers are not stored in the purchase history database in this process, only sales contract terms from actual purchases are entered into the purchase history database.

In order to provide a useful purchase history database analyzable by the logic program, the process preferably includes a data normalizing step 24 of converting purchase contract term data to standard reporting units recognizable and usable by the logic program for analyzing the database. The normalizing step may be manually performed by the system operator after receiving the purchase contract term data for entry into the database. Alternatively the data normalization step may be automatically conducted by way of software integratable with a data provider company's existing procurement software. Examples of data normalization techniques include standardizing the format of prices, dates, units of measure, item description, case quantity, color, and such.

It should be apparent that the usefulness of the present method to a user is dependent upon the validity and statistical integrity of the purchase history database created therein. Accordingly, the purchase history database should be current, true, and contain a large enough number of sets of sales contract terms so that an analysis of the database is statistically meaningful.

The sales history database is more meaningful as more contract terms affecting the final purchase price are stored in the database for comparison. In addition to price and quantity, delivery terms and supplier identifier terms are preferably included in the database. Examples of suitable delivery terms include sale or delivery date, mode of delivery, destination, and insurance. Examples of suitable supplier identifier terms include the vendor name, the manufacturer name, and the shipment origination site. In the preferred embodiment of the present invention, the purchase history database includes sets of data for many different items. In such a case, the applicable terms stored would likely differ for from one item to the next.

In order to keep the purchase history database current, the step of building a purchase history database is preferably repetitively conducted on an ongoing basis wherein additional sets of sales contract terms controlling previous purchases of the item are periodically added into the purchase history database. The database is most preferably continuously updated.

In order to keep the purchase history database true, the system operator preferably engages in an activity designed for verifying data prior to inputting the data into the database. This is illustrated as step 26 in FIG. 2. Suitable quality assurance methods include data filtering by verifying the accuracy of each additional set of sales contract terms prior to adding the additional set of sales contract terms into the purchase history database against, for example, actual payment records. Other data filtering methods include verifying that each additional set of sales contract terms falls within a predetermined acceptable range of deviation from the existing purchase history database prior to adding the additional set of sales contract terms into the purchase history database. Further, the integrity of the sales contract terms collected from previous buyers is likely to be increased through anonymity. Therefore, the database building step of the business method preferably includes a step of disassociating previous buyer indentifier information from the sales contract terms for that previous buyer.

In the preferred business model using the present method, a buying agent of a company is a user subscribing to the fairness determining method while the accounts payable department of the same company serves as a provider of purchase records for building the purchase history database. This business model poses a relatively low likelihood of intentionally false information being provided to the system operator due to the fact that a buyer user would have very little incentive to cause his company to provide false purchase contract term data to the system operator. Being based upon actual purchase price negotiated, the present method is a stark improvement over previously existing comparison-type negotiation aid tools comparing various prices advertised by different vendors. While a vendor company is normally both a seller and a buyer in commerce, the accounts payable for the vendor company has little incentive to skew the purchase contract terms reported for items bought since a vendor company does not typically buy the same items that it sells to others.

The present process is useful for determining the fairness of an offer to buy or sell an item. While the process is valuable for determining how well a person negotiated a previous purchase in light of the purchases negotiated for the same item by other people, the process is most beneficial when used to determine fairness of an offer before the offer is extended to the opposite party. It should be obvious to those in the analysis art that this process will provide a much more meaningful fairness indicator when a greater number of companies provide their purchasing data for inputting into the database.

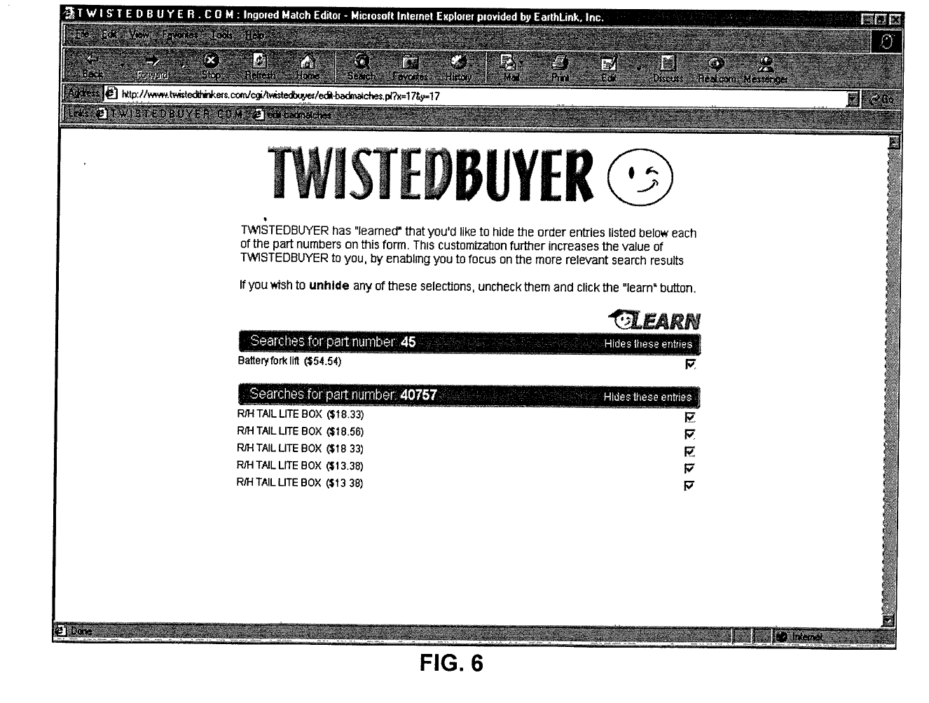

Since procurement negotiation strength does somewhat depend on the strength of the company negotiating in the market, an even more realistic determination of the fairness of an offer is obtained by comparing an offer against only those sets of sales contract terms in the database negotiated by companies of similar size. The user screen shown in FIG. 5 displays a right-hand column by which the user may opt to cull away sets of sales contract terms, such as sets of terms provided from buyers representing a drastically different sized company. As shown in FIG. 6, these culled, or hidden, sets of sales contract terms are not used in calculating the fairness indicator. Other such class specific comparisons may be, for example, geographically limited or date limited. An insightful “procurement quotient” may be obtained through the present method by comparing the offer against a fairness indicator calculated as a function of the sets of sales contract terms falling within a particular class, with company size being the preferred comparison class.

In the drawings, examples, and specification, there have been disclosed typical preferred embodiments of the invention and, although specific terms are employed, they are used in a generic and descriptive sense only and not for purposes of limitation, the scope of the invention being set forth in the following claims.

1. A method for using a computer system to determine the fairness of an offer for an item, said method comprising:
providing a database program adapted for storing multiple sets of data;
building a purchase history database for at least one item by inputting a plurality of sets of sales contract terms controlling a plurality of previous purchases of the item by a group of previous buyers into the database program, each of the plurality of sets of sales contract terms controlling one of the plurality of purchases made by one member of the group of previous buyers, each of the plurality of sets of sales contract terms including an item identifier, a price paid, and a quantity bought;
providing a logic program adapted for interfacing with the database program and analyzing the purchase history database;
calculating a fairness indicator for the item by analyzing the purchase history database using the logic program; and
determining the fairness of an offer by comparing the offer to the fairness indicator, the offer including an item identifier, a price and a quantity.

2. The method of claim 1 wherein said step of building a purchase history database is a repetitive step wherein additional sets of sales contract terms controlling previous purchases of the item are periodically added into the purchase history database.

3. The method of claim 2 further including a step of data filtering by verifying the accuracy of each additional set of sales contract terms prior to adding the additional set of sales contract terms into the purchase history database.

4. The method of claim 2 further including a step of data filtering by verifying that each additional set of sales contract terms falls within a predetermined acceptable range of deviation from the purchase history database prior to adding the additional set of sales contract terms into the purchase history database.

5. The method according to claim 1 further wherein each of the plurality of sets of sales contract terms used in said database building step is provided by the previous buyer correlating thereto.

6. The method according to claim 5 wherein said database building step includes a step of disassociating previous buyer identifier information from the plurality of sets of sales contract terms in the purchase history database.

7. The method of claim 1 wherein the step of determining the fairness of the offer includes inputting the offer into the logic program for comparison to the fairness indicator.

8. The method of claim 1 wherein the purchase history database includes a plurality of sets of sales contract terms for a plurality of different items.

9. The method of claim 1 wherein at least some of the sets of sales contract terms further includes a delivery term.

10. The method of claim 1 wherein at least some of the sets of sales contract terms further includes a supplier identifier.

11. The method of claim 1 wherein said step of determining the fairness of the offer is conducted prior to extending the offer in a sales negotiation.

12. The method of claim 1 wherein the offer is an offer to buy the item.

13. The method of claim 1 wherein the fairness indicator is calculated as a function of the sets of sales contract terms negotiated by previous buyers representing similar size companies.

14. The method of claim 1 wherein the computer system is a network system wherein the purchase history database and the logic program are located on a host site connected to at least one user site, the logic program being adapted for communication with the user site.

15. A business method for providing a user with a useful indicator of the fairness of a offer for an item, comprising:
operating a computer system including a purchase history database, a logic program, and a user interface, wherein the database comprises a plurality of sets of sales contract terms controlling a plurality of previous purchases of an item by a group of previous buyers, wherein the logic program is adapted for calculating a fairness indicator correlating to the plurality of sets of sales contract terms by analyzing the plurality of sets of sales contract terms, and wherein the user interface is adapted for communicating the fairness indicator to a user in a context sufficient so that the user can comparatively determine the fairness of an offer for the item.

16. The method of claim 15 wherein said operating includes repetitively adding additional sets of sales contract terms controlling previous purchases of the item into the purchase history database.

17. The method of claim 15 further wherein each of the plurality of sets of sales contract terms is provided by way of the previous buyer correlating thereto.

18. A computerized business method for determining the fairness of a purchase of an item relative to previous purchases of the item, comprising: comparing an offer for an item to a fairness indicator determined by statistically analyzing a plurality of sets of sales contract terms controlling a plurality of previous purchases of the item by a group of previous buyers, each of the sets of sales contract terms controlling a previous purchase.

19. The method of claim 18 further including adding additional sets of sales contract terms controlling previous purchases of the item to the plurality of sets of sales contract terms prior to determining the fairness indicator.

20. The method of claim 18 further wherein each of the plurality of sets of sales contract terms is provided by way of the previous buyer correlating thereto.
